(19) United States
(12) Patent Application Publication
(10) Pub. No.: US 2008/0257433 A1
(43) Pub. Date: Oct. 23, 2008

(54) BLEED VALVE APPARATUS

(75) Inventor: Hiroo TSUJIMOTO, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/105,566

(22) Filed: Apr. 18, 2008

(30) Foreign Application Priority Data
Apr. 19, 2007 (JP) 2007-110380

(51) Int. Cl. F16K 11/00; F15B 13/043; F16K 11/07

(52) U.S. Cl. 137/625.61; 137/625.64; 251/35

(57) ABSTRACT

A seat member forms a bleed chamber between a spool and the seat member and has a bleed port communicated with a low pressure side. The spool is seatable against a seat of the seat member, which is formed around the bleed chamber, to disable substantial communication between the bleed chamber and a supply port, which supplies oil to the bleed chamber. An opening and closing valve plug is seatable against another seat of the seat member, which is formed around the bleed port, to close the bleed port. A push member is placed between the spool and the valve plug. When a solenoid actuator applies a drive force to the valve plug, the push member is driven by the valve plug to directly push the spool and thereby to lift the spool away from the seat of the seat member.

### CROSS REFERENCE TO RELATED APPLICATION

This application is based on and incorporates herein by reference Japanese Patent Application No. 2007-110380 filed on Apr. 19, 2007.

### BACKGROUND OF THE INVENTION

1. Field of the Invention

The present invention relates to a bleed valve apparatus.

2. Description of Related Art

Japanese Unexamined Patent Publication No. 2002-357281 (U.S. Pat. No. 6,615,869) teaches a solenoid hydraulic pressure control valve apparatus, as an example of a bleed valve apparatus, in which a movable valve is driven by a hydraulic pressure of a bleed chamber.

The solenoid hydraulic pressure control valve apparatus of Japanese Unexamined Patent Publication No. 2002-357281 (U.S. Pat. No. 6,615,869) will be described with reference to FIGS. 5 to 6B.

The solenoid hydraulic pressure control valve apparatus is a valve apparatus, in which a spool 104 (an example of a movable valve) is axially driven by a pressure of a bleed chamber 134 in a spool valve 101 having a three-way valve structure. The solenoid hydraulic pressure control valve apparatus further includes a spool return spring 105 and a solenoid bleed valve 102. The spool return spring 105 urges the spool 104 in one sliding direction (a right direction in FIG. 5), and the solenoid bleed valve 102 controls the pressure of the bleed chamber 134.

The solenoid bleed valve 102 includes a seat member 131, an opening and closing valve plug 132 and a solenoid actuator 133. The bleed chamber 134, which receives pressurized oil, is formed between the spool 4 and the seat member 131. A bleed port 135 is formed in the seat member 131 to communicate between the bleed chamber 134 and a low pressure side. The valve plug 132 opens and closes the bleed port 135. The solenoid actuator 133 drives the valve plug 132. When the spool 104 is seated (contacts) against the seat member 131, the communication between the bleed chamber 134 and a supply port 112, which supplies the oil to the bleed chamber 134, is interrupted, i.e., is disabled by the spool 104. When the spool 104 is lifted away from the seat member 131, the supply port 112 and the bleed chamber 134 are communicated with each other.

The seat member 131 is a generally cylindrical body, in which the bleed chamber 134 is formed. Furthermore, an annular seat 162 is provided in an end surface of the seat member 131 to contact the spool 104 along an entire circumferential extent of the annular seat 162.

When the spool 104 is seated against the seat member 131 (specifically, the annular seat 162), the communication between the supply port 112 and the bleed chamber 134 is interrupted by the spool 104, as described above.

When the spool 104 is seated against the seat member 131 to completely interrupt the communication between the supply port 112 and the bleed chamber 134, oil cannot be supplied to the bleed chamber 134. Thus, even when the valve plug 132 blocks the bleed port 135, the hydraulic pressure is not generated in the bleed chamber 134.

In view of the above point, there is provided a fine communication means for guiding oil of the supply port 112 to the bleed chamber 134 even in the state where the spool 104 is seated against the annular seat 162.

At the time of lifting the spool 104 away from the seat member 131, a hydraulic pressure (hereinafter, referred to as a lifting hydraulic pressure) for lifting the spool 104 away from the seat member 131 needs to be generated in the bleed chamber 134 by reducing an opening degree of the bleed port 135 (for example, by closing the bleed port 135) and increasing the flow amount of the oil, which is supplied from the fine communication means to the bleed chamber 134, to increase the hydraulic pressure of the bleed chamber 134.

Here, it is conceivable to use only the fine gaps 163, which are created by the surface roughness of the contact surfaces of the spool 104 and of the seat member 131, as the fine communication means.

However, when the fine gaps 163 are used alone as the fine communication means, the flow amount of oil, which flows from the fine gaps 163 into the bleed chamber 134, is relatively small, so that the time, which is required to increase the hydraulic pressure of the bleed chamber 134 to the lifting hydraulic pressure, is lengthened. Therefore, as indicated at a left end (no orifice) of a solid line A in FIG. 7, the response time required for lifting the spool 104 away from the seat member 131 is disadvantageously lengthened.

In view of the above point, in the above-described Japanese Unexamined Patent Publication No. 2002-357281 (U.S. Pat. No. 6,615,869), as shown in FIG. 6A, an orifice J1 (a small groove formed in the annular seat 162) is formed in a portion of the annular seat 162 to communicate between the supply port 112 and the bleed chamber 134. In this way, even in the state where the spool 104 is seated against the seat member 131, the oil of the supply port 112 can be supplied to the bleed chamber 134 through the orifice J1.

When a flow passage cross sectional area of the orifice J1 is increased, the flow amount of oil, which flows from the orifice J1 to the bleed chamber 134, is advantageously increased. Thereby, it is possible to reduce the time, which is required for the hydraulic pressure of the bleed chamber 134 to reach the lifting hydraulic pressure. Specifically, as indicated by the solid line A in FIG. 7, when the flow passage cross sectional area is increased, the response time, which is required to lift the spool 104 from the seat member 131, can be reduced.

However, in the state where the spool 104 is seated against the seat member 131, the valve plug 132 is placed to open the bleed port 135. In this state, when the flow passage cross sectional area of the orifice 11 is increased, the oil flow amount, i.e., the leak amount of oil, which is drained from the orifice J1 to the low pressure side through the bleed chamber 134, is disadvantageously increased. Specifically, as indicated by a solid line B in FIG. 7, when the flow passage cross sectional area of the orifice J1 is increased, the response can be improved. However, at the same, the leak amount of oil is disadvantageously increased.

As discussed above, the response at the time of lifting the spool 104 away from the seat member 131 conflicts with the leak amount of oil in the state where the spool 104 is seated against the seat member 131. In order to make an appropriate balance between the response and the leak amount of oil, the flow passage cross sectional area of the orifice J1 needs to be precisely controlled to fall within a narrow range indicated by a preset range C in FIG. 7. That is, in the prior art, the processing of the orifice 11 is difficult.

### SUMMARY OF THE INVENTION

The present invention addresses the above disadvantages. Thus, it is an objective of the present invention to provide a bleed valve apparatus, which enables relatively good response, elimination of an orifice and limitation of a leak amount.

To achieve the objective of the present invention, there is provided a bleed valve apparatus, which includes a valve body, a movable valve, a seat member, an opening and closing valve plug, a drive means and a push member. The movable valve is displaceably supported in the valve body. The seat member forms a bleed chamber between the movable valve and the seat member and has a bleed port, which communicates the bleed chamber to a low pressure side. The movable valve is liftable from and seatable against a first seat of the seat member, which is formed around the bleed chamber, to respectively enable and disable substantial communication between the bleed chamber and a supply port, which supplies oil to the bleed chamber. The valve plug is liftable from and seatable against a second seat of the seat member, which is formed around the bleed port, to respectively open and close the bleed port. The drive means is for driving the valve plug relative to the second seat of the seat member. The push member is placed between the movable valve and the valve plug. When the drive means applies a drive force to the valve plug to move the valve plug toward the second seat of the seat member, the push member is driven by the valve plug to directly push the movable valve and thereby to lift the movable valve away from the first seat of the seat member.

### BRIEF DESCRIPTION OF THE DRAWINGS

The invention, together with additional objectives, features and advantages thereof, will be best understood from the following description, the appended claims and the accompanying drawings in which:

FIG. 1A is an axial cross sectional view of a solenoid hydraulic pressure control valve apparatus of an N/L type according to a first embodiment of the present invention;

FIG. 1B is a side view of a shaft having an opening and closing valve plug in the solenoid hydraulic pressure control valve apparatus of FIG. 1A;

FIG. 2 is an enlarged partial cross sectional view of the solenoid hydraulic pressure control valve apparatus of the first embodiment;

FIG. 3 is an axial cross sectional view of a solenoid hydraulic pressure control valve apparatus of an N/H type according to a second embodiment of the present invention;

FIG. 4 is a cross sectional view of a spool of a solenoid hydraulic pressure control valve apparatus according to a third embodiment of the present invention;

FIG. 5 is an axial cross sectional view of a solenoid hydraulic pressure control valve apparatus of an N/H type according to a prior art;

FIG. 6A is an axial end view of a seat member of the solenoid hydraulic pressure control valve apparatus of FIG. 5;

FIG. 6B is an axial cross sectional view of the seat member of FIG. 6A; and

FIG. 7 is a graph showing a relationship between response time and leak amount in view of a flow passage cross sectional area of an orifice.

### DETAILED DESCRIPTION OF THE INVENTION

### First Embodiment

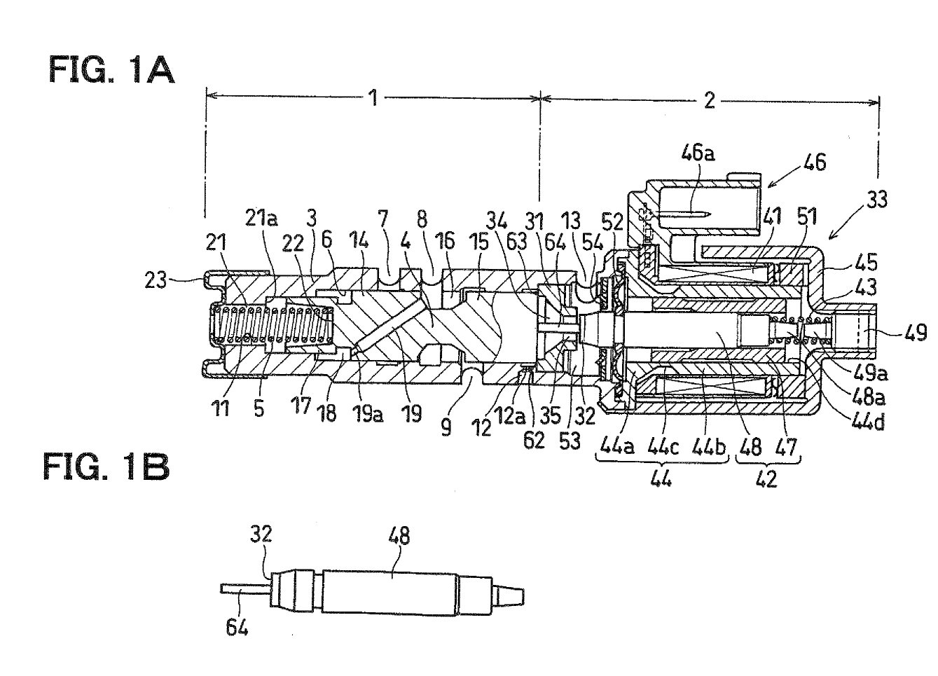

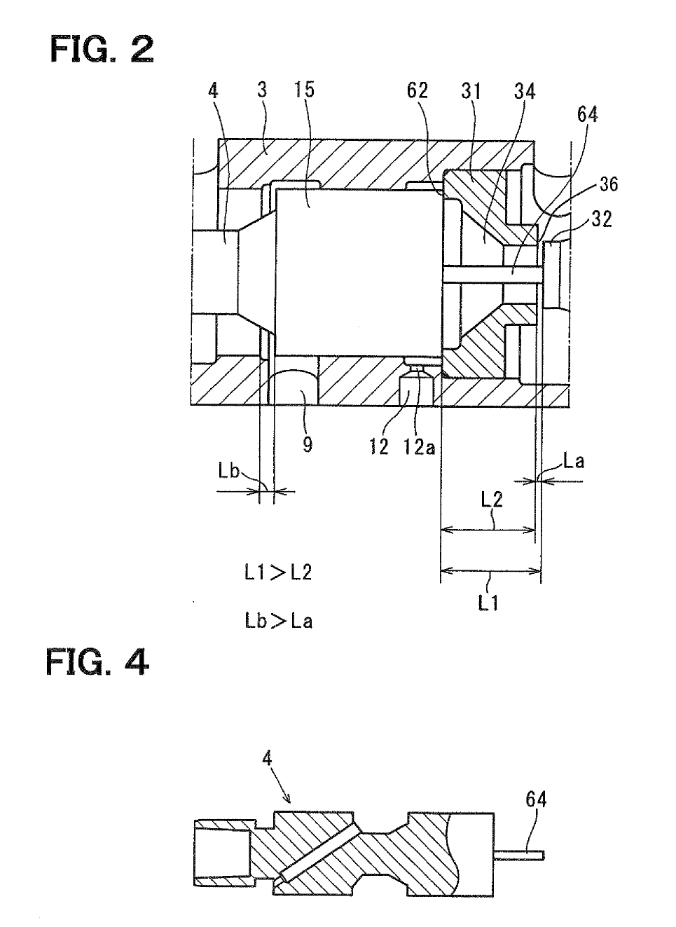

With reference to FIGS. 1A to 2, a description will now be made to a first embodiment in which a bleed valve apparatus according to the present invention is implemented as a solenoid hydraulic pressure control valve apparatus. In the first embodiment, a main structure of the solenoid hydraulic pressure control valve apparatus will be described first, and then characteristics of the first embodiment will be described.

Now, a basic structure of the solenoid hydraulic pressure control valve apparatus will be described.

The solenoid hydraulic pressure control valve apparatus shown in FIG. 1A is installed, for example, in a hydraulic pressure control device of an automatic transmission. The solenoid hydraulic pressure control valve apparatus includes a spool valve 1 and a solenoid bleed valve 2. The spool valve 1 serves as a hydraulic pressure control valve, which switches the hydraulic pressure or adjusts the hydraulic pressure. The solenoid bleed valve 2 drives the spool valve 1.

In the solenoid hydraulic pressure control valve apparatus of the first embodiment, when a solenoid actuator 33 (described below), which forms a part of the solenoid bleed valve 2, is placed in an off state, an opening degree of a bleed port 35 (described below) is maximized. Furthermore, in the off state of the solenoid actuator 33, a degree of communication between an input port 7 and an output port 8 is minimized (closed), and a degree of communication between the output port 8 and a drain port 9 is maximized. Therefore, the solenoid hydraulic pressure control valve apparatus of the first embodiment can be considered as a normally low (N/L) type.

The spool valve 1 includes a sleeve 3, spool 4 and a return spring 5.

The sleeve 3 is formed into a generally cylindrical body and is received in a case of a hydraulic pressure controller (not shown).

The sleeve 3 includes a slide hole 6, the input port 7, the output port 8 and the drain port 9. The slide hole 6 axially slidably supports the spool 4 therein. The input port 7 communicates with an oil discharge outlet of an oil pump (hydraulic pressure generating means) and receives input hydraulic pressure (oil) according to a driving state. An output pressure, which is adjusted by the spool valve 1, is outputted from the output port 8. The drain port 9 communicates with a low-pressure side (such as an oil pan).

A spring receiving hole 11 is formed at a left end of the sleeve 3 in FIG. 1A to receive the return spring 5 into the interior of the sleeve 3.

These oil ports (e.g., the input port 7, the output port 8 and the drain port 9) are holes that are formed in a peripheral wall of the sleeve 3. The input port 7, the output port 8, the drain port 9, a supply port 12 and a bleed drain port 13 are formed in the peripheral wall of the sleeve 3 in this order from the left side to the right side in FIG. 1A. The oil is supplied to a bleed chamber 34 through the supply port 12. Furthermore, the oil, which is drained from the bleed chamber 34, is drained out of the sleeve 3 through the bleed drain port 13.

In this instance, the supply port 12 includes a control orifice 12a, which limits the maximum flow amount of oil, which passes through the supply port 12 to limit the oil consumption at the time of valve opening of an opening and closing valve plug 32 (described below).

The supply port 12 communicates with the input port 7 through a pressure reducing valve at outside of the sleeve 3 (within the hydraulic pressure controller). The drain port 9 and the bleed drain port 13 communicate with each other at outside of the sleeve 3 (within the hydraulic pressure controller).

The spool 4 is slidably disposed inside the sleeve 3. Furthermore, the spool 4 includes an input seal land 14 and a drain seal land 15. The input seal land 14 seals the input port 7, and the drain seal land 15 seals the drain port 9. A distribution chamber 16 is formed between the input seal land 14 and the drain seal land 15.

The spool 4 further includes a feedback (F/B) land 17, which has an outer diameter smaller than that of the input seal land 14r on the left side of the input seal land 14 in FIG. 1A. An F/B chamber 18 is formed due to a land difference (a diameter difference) between the input seal land 14 and the F/B land 17.

An F/B port 19, which communicates between the distribution chamber 16 and the F/B chamber 18, is formed in the interior of the spool 4. The F/B port 19 exerts an F/B hydraulic pressure, which corresponds to the output pressure, at the spool 4. An F/B orifice 19a is formed in the F/B port 19 to produce an appropriate F/B hydraulic pressure in the F/B chamber 18.

Thus, when the hydraulic pressure (output pressure), which is applied to the F/B chamber 18, is increased, an axial force (a rightward force in FIG. 1A) is exerted to the spool 4 due to a differential pressure caused by the land difference between the input seal land 14 and the F/B land 17. In this way, stable displacement (stable movement) of the spool 4 is achieved, and thereby it is possible to limit fluctuations in the output pressure, which would be caused by fluctuations in the input pressure.

The spool 4 is held stationary at a position where the spring load of the return spring 5, the drive force of the spool 4 generated by the pressure of the bleed chamber 34, and the axial force resulting from the land difference between the input seal land 14 and the F/B land 17 are balanced.

The return spring 5 is a spiral coil spring, which urges the spool 4 in a valve closing side. The valve closing side is a side where the input side seal length is increased to reduce the output pressure (the right side in FIG. 1A). The return spring 5 is received in a compressed state in a spring chamber 21 located at a left side of the sleeve 3 in FIG. 1A. The return spring 5 is held such that one end of the return spring 5 contacts a bottom surface of a recess 22, which is formed in the interior of the F/B land 17, and the other end of the return spring 5 contacts a bottom surface of a spring seat 23 that is fixed to the left end of the sleeve 3 by welding or swaging or the like in FIG. 1A.

A step 21a, which is formed inside the spring chamber 21, limits the maximum valve opening position (the maximum spool lift position) of the spool 4 when the left end of the spool 4 in FIG. 1A contacts the step 21a.

The solenoid bleed valve 2 drives the spool 4 leftward in FIG. 1A by the pressure of the bleed chamber 34 that is formed on the right of the spool 4 in FIG. 1A. The solenoid bleed valve 2 includes a seat member 31 and the solenoid actuator 33 having the valve plug 32.

The seat member 31 is configured into a generally annular body, which is fixed in the interior of the sleeve 3 on the right side in FIG. 1A. The seat member 31 forms the bleed chamber 34 between the seat member 31 and the spool 4 to drive the spool 4. Furthermore, the bleed port 35 is formed at the center portion of the seat member 31 to communicate between the bleed chamber 34 and the low pressure side (the aforementioned bleed drain port 13).

The seat member 31 determines the maximum valve closing position of the spool 4 (the spool's seated position) when the spool 4 is seated against the left end surface of the seat member 31 in FIG. 1A. Furthermore, the valve plug 32, which is provided at the axial end of a shaft 48, can contact a seat 36 (FIG. 2) formed at the right end surface of the seat member 31 in FIG. 1A. When the valve plug 32 contacts the seat 36 at the right end surface of the seat member 31 in FIG. 1A, the bleed port 35 is closed.

The solenoid actuator 33 includes a coil 41, a slider 42, a slider return spring 43, a stator 44, a yoke 45 and a connector 46. The solenoid actuator 33 drives the valve plug 32 to control the opening degree of the bleed port 35. When the valve plug 32 reduces the opening degree of the bleed port 35, the internal pressure of the bleed chamber 34 increases, so that the spool 4 is moved in the valve opening direction (leftward in FIG. 1A). In contrast, when the valve plug 32 increases the opening degree of the bleed port 35, the internal pressure of the bleed chamber 34 decreases, so that the spool 4 is moved in the valve closing direction (rightward in FIG. 1A).

When the coil 41 is energized, the coil 41 generates magnetic force to create a magnetic flux loop, which passes through the slider 42 (specifically, a moving core 47 discussed later) and a magnetic stator arrangement (the stator 44 and the yoke 45). The coil 41 has a conductive wire, which is coated with an insulation coating and is wound around a dielectric resin bobbin.

The slider 42 includes the moving core 47 and the shaft 48. The moving core 47 is configured into a tubular body, which is axially magnetically attracted by the magnetic force produced by the coil 41. The shaft 48 is press fitted into the tubular moving core 47 and has the valve plug 32, which is directly formed at the axial end of the shaft 48.

The moving core 47 is a generally cylindrical tubular body made of magnetic metal (e.g., iron: a ferromagnetic material that forms a magnetic circuit) and directly slidably engaged with the inner peripheral surface of the stator 44.

The shaft 48 is configured as a rod, which is made of a non-magnetic material having a high hardness (e.g., stainless steel) and is press fitted into the moving core 47. The valve plug 32 is formed at the left end of the shaft 48 in FIG. 1A to open and close the bleed port 35.

The slider return spring 43 is a helical coil spring, which urges the shaft 48 in the valve closing direction (the direction for closing the bleed port 35 with the valve plug 32). The slider return spring 43 is compressed and disposed between the right end portion of the shaft 48 in FIG. 1A and an adjuster (adjusting screw) 49 that is axially screwed into the center of the yoke 45.

In the solenoid bleed valve 2 of the first embodiment, at the off-time of the solenoid actuator 33 (time of not applying the leftward magnetic force to the moving core 47 in FIG. 1A), the valve plug 32 is moved in the right direction in FIG. 1A by the discharge pressure of the oil applied from the bleed port 35 to the valve plug 32, so that the bleed port 35 is opened.

The slider return spring 43 provides the urging force to the slider 42 to adjust the operational characteristics of the slider 42. At the off-time of the solenoid actuator 33, the slider return spring 43 enables the rightward movement of the shaft 48 in FIG. 1A by the discharge pressure of the oil applied from the bleed port 35 to the valve plug 32 and applies the leftward urging force to the shaft 48 in the valve closing direction in FIG. 1A. The spring load of the slider return spring 43 is adjusted by adjusting an amount thread engagement (an amount of threaded in) of the adjuster 49.

A shaft end projection 48a is provided in the right end portion of the shaft 48 in FIG. 1A. The shaft end projection 48a projects in the right direction in FIG. 1A at radially inward of the slider return spring 43. Furthermore, an adjuster end projection 49a is provided in the left end portion of the adjuster 49 in FIG. 1A. The adjuster end projection 49a projects in the left direction in FIG. 1A at radially inward of the slider return spring 43. The shaft end projection 48a and the adjuster end projection 49a contact with each other when the shaft 48 is moved in the right direction in FIG. 1A.

The stator 44 is made of magnetic metal (e.g., iron: a ferromagnetic material that forms a magnetic circuit). The stator 44 includes an attracting stator segment 44a, a slidable stator segment 44b and a magnetically saturated groove (a portion having an increased magnetic resistance) 44c. The attracting stator segment 44a magnetically attracts the moving core 47 in the axial direction (the left direction in FIG. 1A for closing the bleed port 35 with the valve plug 32). The slidable stator segment 44b surrounds the moving core 47 and radially transfers the magnetic flux relative to the moving core 47. The magnetic saturation groove 44c limits the amount of magnetic flux, which passes between the attracting stator segment 44a and the slidable stator segment 44b, to pass the magnetic flux through the attracting stator segment 44a, the moving core 47 and the slidable stator segment 44b in this order.

An axial hole 44d is formed in the stator 44 to axially slidably supports the moving core 47. The axial hole 44d is a through hole, which extends from one end to the other end of the stator 44 and has a constant inner diameter throughout its length.

The attracting stator segment 44a is magnetically coupled with the yoke 45 through a flange, which is axially clamped between the yoke 45 and the sleeve 3. Furthermore, the attracting stator segment 44a includes a tubular portion. The tubular portion of the attracting stator segment 44a overlaps with the moving core 47 in the axial direction when the moving core 47 is attracted to the attracting stator segment 44a. An outer peripheral surface of the tubular portion of the attracting stator segment 44a is tapered to limit a change in the magnetic attractive force with respect to the amount of stroke of the moving core 47.

The slidable stator segment 44b is configured into a generally cylindrical tubular body, which covers around the moving core 47. A magnetic transferring ring 51, which is made of magnetic metal (e.g., iron: a ferromagnetic material that forms a magnetic circuit), is placed radially outward of the slidable stator segment 44b, so that the slidable stator segment 44b and the yoke 45 are magnetically coupled with each other. Furthermore, the slidable stator segment 44b directly slidably engages the moving core 47 in the axial hole 44d to axially slidably support the moving core 47. Also, the slidable stator segment 44b radially transfers the magnetic flux relative to the moving core 47.

The yoke 45 is a generally cup shaped body made of magnetic metal (e.g., iron: the ferromagnetic material that forms the magnetic circuit), which surrounds the coil 41 and conducts the magnetic flux. Furthermore, the yoke 45 is securely connected to the sleeve 3 upon bending claws, which are formed at an opening end of the yoke 45, against the sleeve 3.

A diaphragm 52 is provided in the connection between the sleeve 3 and the yoke 45 to partition between the interior of the sleeve 3 and the interior of the solenoid actuator 33. The diaphragm 52 is formed as a generally annular rubber. An outer peripheral portion of the diaphragm 52 is clamped between the sleeve 3 and the stator 44, and a center portion of the diaphragm 52 is fitted into a groove formed in an outer peripheral surface of the shaft 48. Thereby, the diaphragm 52 limits intrusion of the oil and foreign objects, which are present in the interior of the sleeve 3 (in an interior of a pressure drain chamber 53 described below), into the interior of the solenoid actuator 33.

The pressure drain chamber 53 is formed in a right side part of the interior of the sleeve 3 in FIG. 1A. The pressure drain chamber 53 is partitioned by the seat member 31 and the diaphragm 52 and is communicated with the bleed drain port 13. A pressure resistant shield plate 54 is placed on a pressure drain chamber 53 side of the diaphragm 52 and is configured into a generally ring shaped plate (an annular plate). The pressure resistant shield plate 54 limits direct application of the pressure of the pressure drain chamber 53 to the diaphragm 52.

The connector 46 is a connecting means for electrically connecting with an electronic control unit (not shown), which controls the solenoid hydraulic pressure control valve apparatus, through connection lines. Terminals 46a, which are connected to two ends, respectively, of the coil 41, are provided in an interior of the connector 46.

The electronic control unit controls the amount of electric power (an electric current value) supplied to the coil 41 of the solenoid actuator 33 by controlling a duty ratio of the supplied current. The axial position of the slider 42 (the moving core 47 and the shaft 48) is linearly changed against the discharge pressure of the oil from the bleed port 35 by controlling the amount of electric power supplied to the coil 41, so that the axial position of the valve plug 32 is changed to control the opening degree of the bleed port 35. In this way, the hydraulic pressure in the bleed chamber 34 is controlled.

In this manner, the electronic control unit controls the hydraulic pressure in the bleed chamber 34. The hydraulic pressure in the bleed chamber 34 is thus controlled, so that the axial position of the spool 4 is controlled. In this way, a ratio between an effective input side seal length of the input seal land 14 between the input port 7 and the distribution chamber 16 and an effective drain side seal length of the drain seal land 15 between the distribution chamber 16 and the drain port 9 is controlled. Thus, the output pressure of the oil exerted at the output port 8 is controlled.

Now, characteristics of the first embodiment will be described.

The seat member 31 is the annular member, in which the bleed chamber 34 is formed. An annular seal 62, which is engageable with the end portion of the spool 4 all along a circumferential extent thereof, is formed in the left end surface of the seat member 31 in FIG. 1A.

When the spool 4 is seated against the annular seat 62 of the seat member 31, the communication between the supply port 12 and the bleed chamber 34 is disconnected to limit the amount of wasteful flow (leak amount) of oil that is drained through the supply port 12, the bleed chamber 34 and the bleed port 35 in this order.

Next, in order to illustrate advantages of the first embodiment, the background of the first embodiment will be described.

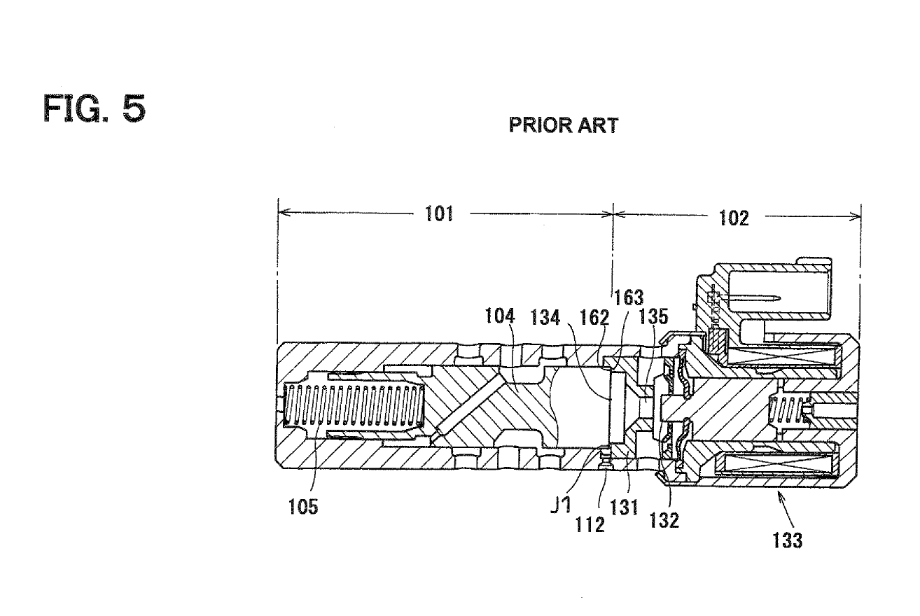

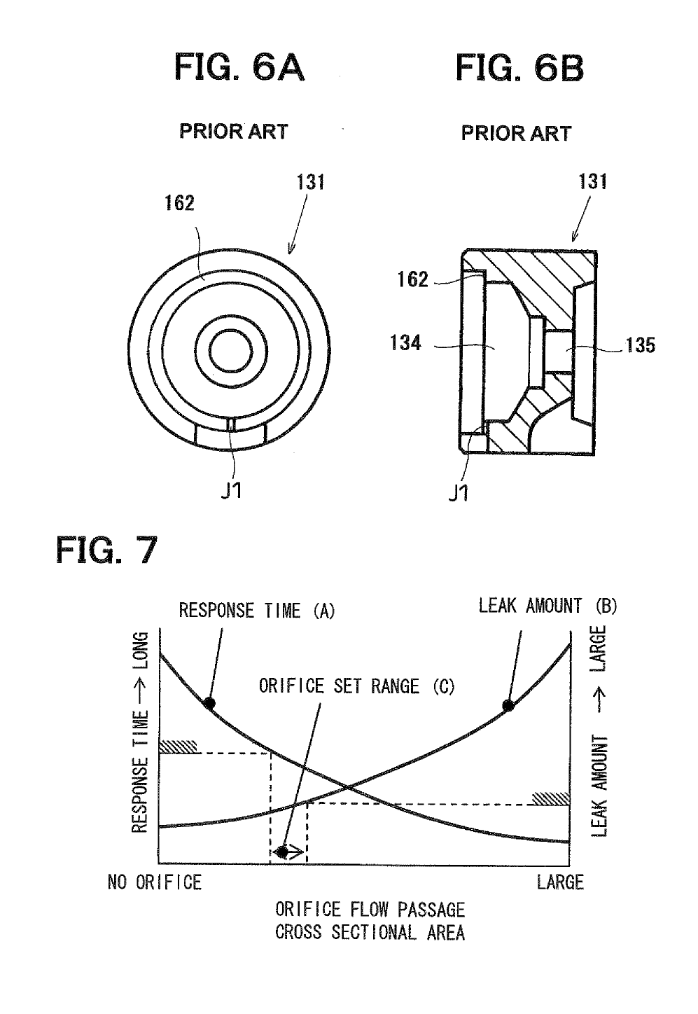

In the conventional structure of FIGS. 5 to 6B, when the spool 104 is seated against the seat member 131 to completely interrupt communication between the supply port 112 and the bleed chamber 134, oil cannot be supplied to the bleed chamber 134. Thus, even when the valve plug 132 blocks the bleed port 135, the hydraulic pressure is not generated in the bleed chamber 134.

In this context, the conventional technique employs the fine communication means, which introduced oil of the supply port 112 into the bleed chamber 134 even in the state where the spool 104 is seated against the seat member 131.

The fine communication means, which is used in the conventional technique, includes the fine gaps 163, which are created by the surface roughness (fine recesses and protrusions) of the contact surfaces of the spool 104 and of the seat member 131, and the orifice J1 (FIGS. 6A and 6B), which is formed in the annular seat 162. A communication opening cross sectional area between the supply port 112 and the bleed chamber 134 at the time of seating of the spool 104 against the seat member 131 is adjusted by the groove width and depth of the orifice J1.

At the time of lifting the spool 104 away from the seat member 131, the lifting hydraulic pressure for lifting the spool 104 away from the seat member 131 needs to be generated in the bleed chamber 134 by reducing the opening degree of the bleed port 135 and increasing the flow amount of oil, which is supplied from the fine communication means to the bleed chamber 134, to increase the hydraulic pressure of the bleed chamber 134.

Here, it is conceivable to use only the fine gaps 163, which are created by the surface roughness of the contact surfaces of the spool 104 and of the seat member 131, as the fine communication means.

However, when the fine gaps 163 are used alone as the fine communication means, the flow amount of oil, which flows from the fine gaps 163 into the bleed chamber 134, is relatively small, so that the time, which is required to increase the hydraulic pressure of the bleed chamber 134 to the lifting hydraulic pressure, is lengthened. Thereby, the response time at the time of lifting the spool 104 away from the seat member 131 is disadvantageously lengthened.

In view of the above point, in the conventional technique, the orifice 11 is additionally formed in the seat member 131 besides the fine gaps 163 of the contact surfaces as the fine communication means to increase the pressure increase rate of the bleed chamber 134.

When the flow passage cross sectional area of the orifice J1 is increased, the flow amount of oil, which flows from the orifice J1 to the bleed chamber 134 is advantageously increased. Thereby, it is possible to reduce the time, which is required for the hydraulic pressure of the bleed chamber 134 to reach the lifting hydraulic pressure. That is, the response time at the time of lifting the spool 104 from the seat member 131 can be advantageously reduced.

However, in the state where the spool 104 is seated against the seat member 131, the valve plug 132 is placed to open the bleed port 135. In this state, when the flow passage cross sectional area of the orifice J1 is increased, the leak amount of oil, which is drained from the orifice J1 to the low pressure side through the bleed chamber 134, is disadvantageously increased. Specifically, when the flow passage cross sectional area of the orifice J1 is increased, the response can be improved. However, at the same time, the leak amount of oil is disadvantageously increased.

Thus, in the conventional technique, the appropriate flow passage cross sectional area of the orifice 11, which can provide the good balance between the response and the leak amount of oil, needs to be determined, and the flow passage area of the orifice J1 needs to be precisely controlled to keep the flow passage cross sectional area of the orifice J1 within the narrow preset range. Therefore, the processing of the orifice J1 is difficult.

Now, the technique of the first embodiment, which addresses the above disadvantages, will be described.

In view of the above-described point, the solenoid hydraulic pressure control valve apparatus of the first embodiment includes a push member 64 between the spool 4 and the valve plug 32. The push member 64 conducts the drive force, which is applied from the solenoid actuator 33 to the valve plug 32, to the spool 4 to lift the spool 4 away from the seat member 31.

As shown in FIG. 1B, the push member 64 is provided between the spool 4 and the axially opposed end portion of the valve plug 32 and is configured as a rod that extends from the valve plug 32 toward the spool 4.

Specifically, the push member 64 is provided at the center axis of the shaft 48, which forms the valve plug 32. The push member 64 is a hard rod-shaped member, which is made of metal and extends toward the spool 4 along the center axis of the shaft 48. The outer diameter of the push member 64 is smaller than the inner diameter of the bleed port 35, so that a radial gap is formed between the inner peripheral surface of bleed port 35 and the outer peripheral surface of the push member 64 in the radial direction to permit smooth flow of the oil therethrough. The push member 64 may be formed integrally with the shaft 48 or may be fixed to the end portion of the shaft 48 by a known connecting means or method, such as press fitting.

With reference to FIG. 2, a description will now be made to the axial length L1 of the push member 64 (the length of projection from the valve plug 32).

The axial length L1 of the push member 64 is set to a length that enables the spool 4 to be lifted away from the seat member 31 in the state where the valve plug 32 is seated against the bleed port 35 (specifically, the seat 36 of the seat member 31). In other words, the axial length L1 of the push member 64 is set such that a gap is left between the valve plug 32 and the seat 36 of the seat member 31 when the push member 64 begins to apply the drive force to the movable valve 4 while the movable valve 4 is still seated against the seat 62 of the seat member 31, as indicated in FIG. 2. More specifically, the axial length L1 of the push member 64 is set to be larger than an axial distance L2 between the seated position of the spool 4 at the seat member 31 and the seated position of the valve plug 32 at the seat member 31, i.e., the axial distance L2 between the seat 62 and the seat 36 of the seat member 31 (i.e., L1>L2).

As discussed above, the axial length L1 of the push member 64 is set to be larger than the axial distance L2 (L1>L2). Thus, in the state where the valve plug 32 is seated against the seat 36 of the seat member 31, the spool 4 is placed to the position where the spool 4 is lifted away from the seat member 31 toward the side where the drain seal land 15 of the spool 4 closes the drain port 9 of the sleeve 3.

In view of this, the above structure is configured such that the drain seal land 15 does not close the drain port 9 even when the spool 4 is driven in the maximum amount in the left direction in FIG. 1A by the push member 64.

Specifically, the difference La between the axial length L1 and the axial distance L2 (L1-L2: the maximum amount of displacement of the spool 4 driven by the push member 64) is set to be less than the axial opening length Lb of the drain port 9 in the state where the spool 4 is seated against the seat member 31 (Lb>La).

A description will now be made to the operation of the solenoid hydraulic pressure control valve apparatus.

In the deenergized state of the solenoid actuator 33, the spool 4 is seated against the seat member 31 by the urging force of the spool return spring 5 in the right direction in FIG. 1A, so that the spool 4 is stopped in the maximum valve closing position (the spool's seated position), and the urging force of the spool return spring 5, which is applied to the spool 4, is conducted to the valve plug 32 through the push member 64. Thus, the valve plug 32 is urged in the right direction in FIG. 1A, so that the slider 42 (the moving core 47 and the shaft 48) is moved in the right direction in FIG. 1A to open the bleed port 35.

In this state where the spool 4 is stopped in the maximum valve closing position, the degree of communication between the input port 7 and the output port 8 is minimized (closed), and the degree of communication between the output port 8 and the drain port 9 is maximized. As a result, the output port 8 is placed in the pressure draining state.

In the deenergized state of the solenoid actuator 33, when the drive electric current is supplied to the solenoid actuator 33, the magnetic attractive force is applied to the moving core 47 in the left direction in FIG. 1A, so that the slider 42 (the moving core 47 and the shaft 48) is moved in the left direction in FIG. 1A.

In this way, the event of moving the spool 4 in the left direction (the lifting direction) through the push member 64 and the event of reducing the opening degree of the bleed port 35 by the valve plug 32 occur simultaneously.

Specifically, the movement of the slider 42 is conducted to the spool 4 through the push member 64, and the spool 4 is moved in the left direction in FIG. 1A to disengaged from the seat member 31. In this way, the supply port 12 and the bleed chamber 34 are directly communicated with each other, and the oil flows from the supply port 12 into the bleed chamber 34.

Right after the lifting of the spool 4 from the seat member 31, the closing degree of the bleed port 35 is small (i.e., the opening degree of bleed port 35 being large). Thus, the majority of the oil, which flows from the supply port 12 into the bleed chamber 34, is drained from the bleed port 35 to limit the increase in the hydraulic pressure of the bleed chamber 34. Therefore, the amount of movement of the spool 4 in the left direction in FIG. 1A becomes small.

When the drive current, which is supplied to the solenoid actuator 33, is increased, the closing degree of the bleed port 35 by the valve plug 32 becomes large (the opening degree of the bleed port 35 becoming small). Thus, the internal pressure of the bleed chamber 34 is increased, and thereby the spool 4 is moved in the left direction in FIG. 1A against the urging force of the spool return spring 5. As discussed above, when the drive current, which is supplied to the solenoid actuator 33, is increased, the degree of communication between the input port 7 and the output port 8 is increased, and at the same time the degree of communication between the output port 8 and the drain port 9 is decreased. Thereby, the output pressure of the output port 8 is increased.

When the drive current, which is supplied to the solenoid actuator 33, is further increased, the valve plug 32 contacts the seat 36 of the seat member 31 to close the bleed port 35. Therefore, the internal pressure of the bleed chamber 34 is maximized by the pressure of oil, which is supplied from the supply port 12 to the bleed chamber 34, and the spool 4 is further moved in the left direction in FIG. 1A against the urging force of the spool return spring 5. In this way, the degree of communication between the input port 7 and the output port 8 is maximized, and the degree of communication between the output port 8 and the drain port 9 is minimized (closed). Thereby, the output pressure of the output port 8 is maximized.

At the time of this maximum output, the spool 4 is stationary held in the balanced position, at which the force generated at the right end surface of the spool 4 in FIG. 1A by the pressure of the bleed chamber 34, the spring load of the spool return spring 5, and the axial force exerted by the F/B at the time of application of the maximum output pressure (the input pressure of the F/B chamber 18) to the F/B chamber 18, are balanced. This stationary position of the spool 4 at the time of the maximum output is normally set to the position, which is located on the right side of the maximum valve opening position (the maximum spool lift position) in FIG. 1A and which does not cause contacting of the spool 4 with the step 21a formed in the spring chamber 21.

When the drive current, which is supplied to the solenoid actuator 33, is reduced, the reversed process, which is the reverse of the above process, is executed. Then, when the power supply to the solenoid actuator 33 is stopped, the spool 4 is seated against the seat member 31 once again to stop at the maximum valve closing position (the spool's seated position).

Next, advantages of the first embodiment will be described.

In the solenoid hydraulic pressure control valve apparatus of the first embodiment, the push member 64 is provided between the spool 4 and the valve plug 32. With this construction, at the time of lifting the spool 4 away from the seat member 31, the drive force of the solenoid actuator 33, which is supplied from the valve plug 32 through the push member 64, drives the spool 4 away from the seat member 31, 50 that the oil is supplied from the supply port 12 to the bleed chamber 34. In this way, the hydraulic pressure, which drives the spool 4, can be generated in the bleed chamber 34 within the short period of time. That is, it is possible to reduce the response time, which is between the time of starting the supplying of the drive current to the solenoid actuator 33 and the time of placing the spool 4 to the target position.

Furthermore, the structure of forcefully lifting the spool 4 from the seat member 31 by the push member 64 is adapted, so that it is not required to guide the oil from the supply port 12 to the bleed chamber 34 in the state where the spool 4 is seated against the seat member 31.

Thus, it is possible to eliminate the orifice J1 of the conventional technique. Thereby, the processing cost of the orifice J1 is no longer required, so that the manufacturing cost of the solenoid hydraulic pressure control valve apparatus can be limited.

Furthermore, it is not required to guide the oil from the supply port 12 to the bleed chamber 34 in the state where the spool 4 is seated against the seat member 31, so that the flow amount of oil, which flows from the supply port 12 to the bleed chamber 34, becomes very small. Specifically, in the first embodiment, in the state where the spool 4 is seated against the seat member 31, the oil, which is guided from the supply port 12 to the bleed chamber 34, flows only through the fine gaps 63, which are formed by the surface roughness of the contact surfaces of the spool 4 and of the seat member 31. Thus, in the state where the spool 4 is seated against the seat member 31, it is possible to limit the leak amount of oil in the state where the spool 4 is seated against the seat member 31.

Specifically, the solenoid hydraulic pressure control valve apparatus of the first embodiment can eliminates the processing of the orifice 11 and can improve the response of the spool 4 from the time of starting the supplying of the drive current to the solenoid actuator 33 to the time of placing the spool 4 in the target position. Furthermore, it is possible to limit the leak amount of oil in the state where the spool 4 is seated against the seat member 31.

Here, it should be noted that in the case where the push member 64 is placed independently unlike the first embodiment, it is required to separately provide a structure, which slidably supports the push member 64 in the bleed port 35 while maintaining the function of the bleed port 35.

In the first embodiment, the push member 64 is provided at the end portion of the valve plug 32 (specifically, the shaft 48), and the push member 64 is supported by the valve plug 32 (the shaft 48). In this way, the push member 64 can be placed between the spool 4 and the valve plug 32 with the simple structure.

### Second Embodiment

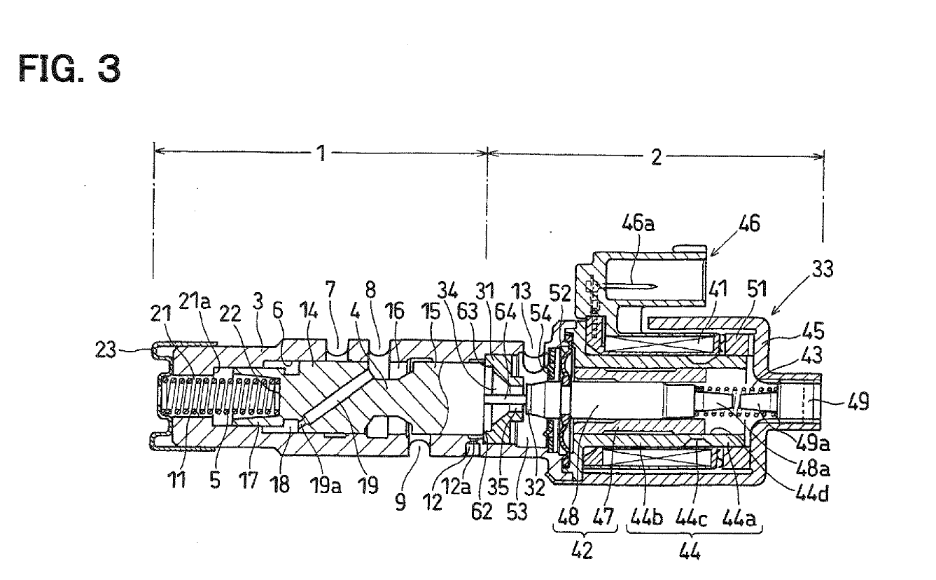

A second embodiment of the present invention will be described with reference to FIG. 3. In the following embodiments, components similar to those of the first embodiment will be indicated by the same reference numerals.

In the solenoid hydraulic pressure control valve apparatus of the first embodiment, when the solenoid actuator 33 is placed in the off state, the opening degree of the bleed port 35 is maximized. Furthermore, in the off state of the solenoid actuator 33, the degree of communication between the input port 7 and the output port 8 is minimized (closed), and the degree of communication between the output port 8 and the drain port 9 is maximized. Therefore, the solenoid hydraulic pressure control valve apparatus of the first embodiment is considered as the normally low (NIL) type.

In contrast, in the solenoid hydraulic pressure control valve apparatus of the second embodiment, when the solenoid actuator 33 is placed in the off state, the bleed port 35 is closed. Furthermore, in the off state of the solenoid actuator 33, the degree of communication between the input port 7 and the output port 8 is maximized, and the degree of communication between the output port 8 and the drain port 9 is minimized (closed). Therefore, the solenoid hydraulic pressure control valve apparatus of the second embodiment is considered as the normally high (N/H) type.

Specifically, in the solenoid hydraulic pressure control valve apparatus of the second embodiment, the slider return spring 43, the stator 44 and the slider 42 are different from those of the first embodiment.

In the off-state of the solenoid actuator 33, the slider return spring (serving as a drive means) 43 urges the valve plug 32 toward the seat 36 of the seat member 31 against the discharge pressure of the oil applied from the bleed port 35 to the valve plug 32, so that the bleed port 35 is closed with the valve plug 32.

The stator 44 magnetically attracts the slider 42 in the right direction in FIG. 3 against the urging force of the slider return spring 43. The attracting stator segment 44a is provided at the right side in FIG. 3, and the slidable stator segment 44b is provided at the left side in FIG. 3.

In the slider 42, the length of the shaft 48 is changed in comparison to that of the first embodiment in response to the change in the position of the attracting stator segment 44a. When viewed in detail, it will be noted that the length of the shaft end projection 48a and the length of the adjuster end projection 49a are also changed. However, such changes may be compensated such that the adjuster 49, which includes the adjuster end projection 49a, is provided in common with that of the first embodiment, and the length of the shaft end projection 48a is changed.

Now, advantages of the second embodiment will be described.

In the solenoid hydraulic pressure control valve apparatus of the second embodiment, similar to the first embodiment, the push member 64 is provided between the spool 4 and the valve plug 32 to lift the spool 4 from the seat member 31 in the state where the valve plug 32 is seated against the seat 36 of the seat member 31 formed around the bleed port 35. Furthermore, at the time of lifting the spool 4 from the seat member 31, the drive force of the solenoid actuator 33, which is applied from the valve plug 32 through the push member 64, is used to lift the spool 4 from the seat 62 of the seat member 31. Thus, advantages similar to those of the first embodiment can be achieved in the second embodiment.

### Third Embodiment

A third embodiment of the present invention will be described with reference to FIG. 4.

In the first embodiment, the push member 64 is provided at the end portion of the valve plug 32 (specifically, the shaft 48).

In contrast, the push member 64 of the third embodiment is provided at the end portion of the spool 4, which is axially opposed to the valve plug 32. The push member 64 is configured as the rod that extends toward the valve plug 32.

Specifically, the push member 64 is provided at the center axis of the spool 4. The push member 64 is a hard rod-shaped member, which is made of metal and extends toward the valve plug 32 along the center axis of the spool 4. The push member 64 may be formed integrally with the spool 4 or may be fixed to the end portion of the spool 4 by the known means or method (e.g., press fitting).

Even with the above construction, advantages similar to those of the first embodiment can be achieved.

The third embodiment may be applied to the solenoid hydraulic pressure control valve apparatus of the N/L type descried with reference to the first embodiment or may be applied to the solenoid hydraulic pressure control valve apparatus of the N/H type descried with reference to the second embodiment.

Next, modifications of the first to third embodiments will be described.

In the above embodiments, the push member 64 is provided to the valve plug 32 (the shaft 48) or the spool 4. Alternatively, the push member 64 may be provided independently from the valve plug 32 (the shaft 48) and the spool 4 and may be axially slidably supported by the seat member 31.

In the above embodiments, the spool valve 1 is formed as the three-way valve. However, the spool valve 1 is not limited to the three-way valve and may be formed as a two-way valve (valve plug 32), a four-way valve or any other structure.

In the above embodiments, the spool 4 is used as the example of the movable valve. However, the movable valve of the present invention is not limited to the spool 4. That is, the movable valve is not limited the one that is axially displaceable, and the present invention may be applied to the valve apparatus, in which the movable valve is displaceable in a rotational direction.

In the above embodiments, the solenoid actuator 33 is used as the example of the drive means. Alternatively, any other appropriate actuator (e.g., an electric motor, a piezoelectric actuator using a piezoelectric stack) may be used in place of the solenoid actuator 33.

In the first and second embodiments, the present invention is applied to the hydraulic pressure control valve used in the hydraulic pressure control device of the automatic transmission. Alternatively, the present invention may be applied to a fluid control valve of any other device, which is other than the automatic transmission.

In the above embodiments, the present invention is applied to the hydraulic pressure control valve apparatus, which is used for the hydraulic pressure control. Alternatively, the present invention may be applied to an oil flow control valve (OCV), which is used to control oil flow.

Additional advantages and modifications will readily occur to those skilled in the art. The invention in its broader terms is therefore not limited to the specific details, representative apparatus, and illustrative examples shown and described.

What is claimed is:

1. A bleed valve apparatus comprising:
a valve body;
a movable valve that is displaceably supported in the valve body;
a seat member that forms a bleed chamber between the movable valve and the seat member and has a bleed port, which communicates the bleed chamber to a low pressure side, wherein the movable valve is liftable from and seatable against a first seat of the seat member, which is formed around the bleed chamber, to respectively enable and disable substantial communication between the bleed chamber and a supply port, which supplies oil to the bleed chamber;
an opening and closing valve plug that is liftable from and seatable against a second seat of the seat member, which is formed around the bleed port, to respectively open and close the bleed port;
a drive means for driving the valve plug relative to the second seat of the seat member; and
a push member that is placed between the movable valve and the valve plug, wherein when the drive means applies a drive force to the valve plug to move the valve plug toward the second seat of the seat member, the push member is driven by the valve plug to directly push the movable valve and thereby to lift the movable valve away from the first seat of the seat member.

2. The bleed valve apparatus according to claim 1, wherein the push member is configured as a rod that extends from an end portion of the valve plug toward the movable valve.

3. The bleed valve apparatus according to claim 1, wherein the push member is configured as a rod that extends from an end portion of the movable valve toward the valve plug.

4. The bleed valve apparatus according to claim 1, wherein:
the push member projects from one of an end surface of the valve plug and an end surface of the movable valve, which are axially opposed to each other, toward the other one of the end surface of the valve plug and the end surface of the movable valve; and
an axial length of the push member, which is measured from the one of the end surface of the valve plug and the end surface of the movable valve, is set such that a gap is left between the valve plug and the second seat of the seat member when the push member begins to apply the drive force to the movable valve while the movable valve is still seated against the first seat of the seat member.

5. The bleed valve apparatus according to claim 1, wherein the supply port is formed through a peripheral wall of the valve body at a location adjacent to the first seat of the seat member.
